(19) United States
(12) Patent Application Publication
(10) Pub. No.: US 2002/0088177 A1
(43) Pub. Date: Jul. 11, 2002

(54) Method and apparatus for watering potted plants

(76) Inventor: Franc Gergek, Richmond Hill (CA)

Correspondence Address: Ogilvy Renault, Suite 1600, 1981 McGill College Avenue, Montreal, QC, H3A 2Y3, CA

(21) Appl. No.: 10/093,510

(22) Filed: Mar. 11, 2002

Related U.S. Application Data
(63) Continuation-in-part of application No. 09/945,620, filed on Sep. 5, 2001.
(60) Provisional application No. 60/330,989, filed on Nov. 6, 2001.
(60) Provisional application No. 60/229,594, filed on Sep. 5, 2000.

(51) Int. Cl. A01G 25/00

(52) U.S. Cl. 47/79

(57) ABSTRACT

A flood and drain watering method for watering potted plants includes introducing water into a bottom space of a flower pot through a tube extending upwardly from the bottom space and out of the open top of the flower pot until a top portion of soil in the flower pot is flooded with water, and then removing all or part of the brown water which is not absorbed by the soil in the flower pot and is collected in the bottom space. With such a flood and drain watering method, the soil in the flower pot is completely saturated with water but there is no excess brown water remaining in the soil to damage the plant roots. This watering method provides an optimum and non-spill watering of potted plants and is conveniently applicable to most flower pots currently available in the market when a converter kit is provided. Indoor and outdoor plant containers specially for use in the implementation of this flood and drain watering method are also described. These plant containers are adapted to use with a water supply and withdrawal system to achieve a fully automatic watering process.

### CROSS-REFERENCE TO RELATED APPLICATIONS

This patent application claims the benefit of Applicant's Provisional Patent Application Serial No. 60/330,989, filed on Nov. 6, 2001 and is a Continuation-in-Part of Applicant's co-pending patent application Ser. No. 09/945,620, filed on Sep. 5, 2001 which claims the benefit of Applicant's Provisional Patent Application Serial No. 60/229,594, filed on Sep. 5, 2000.

### FIELD OF THE INVENTION

The present invention relates to the watering of plants, more particularly to an optimum, non-spill watering method for potted plants and apparatus for implementation of the method.

### BACKGROUND OF THE INVENTION

Most of the flower pots in use have holes at the bottom with saucers attached to them. When watering such plants, people normally observe excess water draining into the saucer, enabling them to ensure that the soil in the flower pot gets enough water to keep the bottom portion of the soil moist. Nevertheless, it is easy to pour too much water into the pot such that the water in the saucer will overflow. The flower pot may be put into a larger tray in order to contain the overflow from the saucer. However, there is no easy way to remove the water in the saucer and the larger tray. The remaining water in the saucer and the tray from previous waterings will reduce the volume of water that can run through the soil. Furthermore, the water from the bottom of the pot is brown and very unsightly. This brown water can leave dirty stains, for example, on carpets or can damage wooden floors when the tray is tipped by accident, causing spills.

Another problem relating to such a watering method is that if the soil in the flower pot is too porous, or if the roots grow in such a way that they create holes in the soil, or if soil dries up in such a way that it leaves gaps between the soil and the interior surface of the pot, the water goes right through the pot with little of it being absorbed by the soil so that the plant roots often are not properly watered.

Flower pots of another type in current use have holes at the bottom and a larger saucer with wicks extending from the bottom into the soil. Openings are provided on sides of the pot for watering and for observing the water level in the saucer. The water at the bottom will slowly seep up through the soil to keep it moist for longer periods of time. If the pot is watered from the top and the water in the saucer from previous watering is not removed, a spillage of brown water may occur. Watering from the side opening directly into the saucer is generally not sufficient to permeate the soil and the soil on the top often remains very dry.

Flower pots without holes at the bottom are much safer to use than pots with holes. However, the main problem with these pots is that it is difficult to know how much water has to be poured in. It is possible that the surface of the soil may be dry while there is a lot of moisture at the roots and thus it is very easy to over-water these plants. Once too much water has been poured into such a flower pot there is no easy way to get it out. If the plant cannot absorb the water in time, or the water does not evaporate quickly enough, the roots may rot and the plant may die.

In efforts to overcome the above mentioned problems, various automatic water supply devices have been developed for supplying water into a flower pot automatically. One example of an automatic water supply device is described in U.S. Pat. Nos. 5,992,092 and 5,749,170, both issued to Furuta on Nov. 30, 1999 and May 12, 1998 respectively. Furuta describes an automatic water supply device including a pot-shaped case having a space enclosing a flower pot in the inside and supported by a reverse bowl shaped bed enclosed in the case. The flower pot holding soil therein contains a plant and includes a drain hole at the bottom. The supporting bed has openings on the lower skirt. The plant is initially watered in the ordinary way by pouring water into the soil and allowing it to drain out the drain hole at the bottom. The pot-shaped case has a bottom portion which serves to contain the excess run-off water. A moisture sensor senses the moisture content of the soil and when conditions require more moisture, the sensor signals an electric pump to pump air through a conduit into the underside of the supporting bed. As a result, compressed air trapped within the reverse bowl shaped supporting bed forces water through openings of the supporting bed and raises the water level to saturate the bottom portion of the soil within the flower pot. After a pre-selected time period has passed the air pressure is released from the supporting bed. As a result, under gravity, the water again drains through the drain hole in the flower pot and is stored within the lower portions of the pot-shaped case.

Another example of an automatic water supply device is described in U.S. Pat. No. 4,937,972, issued to Freitus on Jul. 3, 1990. The device described by Freitus includes a three-compartment plant growth chamber. Soil contained within the upper compartment of the chamber can be initially watered in the ordinary way and any excess water is drained through a screened drain hole into the intermediate reservoir compartment, to be stored therein. An air pipe provides air intake to, and output from the reservoir compartment, if required. A sensor switch senses the moisture content of the soil and when a signal is sent to a pump stored in the lower compartment, water is withdrawn from the reservoir compartment and pumped through a conduit onto the top surface of the soil. A battery housed in the lower compartment provides the necessary power. These automatic water supply devices however still need to be watered in the ordinary way initially, and the brown water will be maintained in the reservoir at the bottom of the pot for a relatively long period of time until it is consumed or until the next watering.

Various flower pots have been designed for improved water-holding and moisture delivery features. Examples of these flower pots are described in U.S. Pat. No. 5,644,868, issued to Lui on Jul. 8, 1997 and U.S. Pat. No. 5,921,025 issued to Smith on Jul. 13, 1999. The flower pots described in those United States patents both include a water reservoir at the bottom thereof and beneath the soil contained therein. Pipes are provided to introduce water into the reservoir and moisture is delivered into the soil from the reservoir, using devices having capillary functions. A floater is provided to indicate water levels in the reservoir. However, watering plants via capillary action may not provide enough water to plants, especially when the soil contained in the flower pot is relatively dry.

Therefore, there is a need for an optimum, non-spill watering method, and apparatus adapted for use with the watering method.

### SUMMARY OF THE INVENTION

It is one object of the present invention to provide an optimum, non-spill watering method for potted plants.

It is another object of the present invention to provide an apparatus for growing plants which is convenient in use with an optimum, non-spill watering method.

In general, the present invention provides a method of watering a plant having roots in soil contained in a container comprising: introducing water under pressure into a bottom of the container through a water passage extending from the bottom of the container upwardly out of the container, until a top portion of soil in the container is flooded with water; and then removing a portion of water not absorbed by the soil from the container.

The removal of the portion of water not absorbed by the soil from the container is preferably conducted through the water passage under a vacuum action. A space is preferably provided between the bottom of the pot and a bottom portion of soil, the space being adapted for collecting water drained from the soil and being in fluid communication with the passage.

In accordance with one aspect of the present invention, a plant container for growing plants which is adapted for use with the above described plant watering method, comprises a container having an open top, a closed bottom and a side wall extending from the top to the bottom. A partition is provided across the container, dividing the container into an upper section for containing soil and a lower section for collecting water. The partition is adapted to permit water to alternately flow therethrough in both directions. A water passage in fluid communication with the lower section extends from the proximity of the bottom of the container to the top of the container for alternately introducing water under pressure into the lower section and removing water under a vacuum action from the lower section. A water detector positioned near the top of the container is adapted to detect a water flood condition of a top surface of soil contained in the upper section of the container. A hydroelectric connector attached to the container is electrically connected to the water detector and is connected in fluid communication with the water passage. The hydroelectric connector is adapted for connection with an external water supply and withdrawal system to alternately introduce water into and remove water from the lower section of the container in a controlled manner.

The external water supply and withdrawal system is adapted to supply water under pressure to the plant container and withdraw water under a vacuum action from the plant container in a fully controlled and programmable manner. This water supply and withdrawal system is described in the Applicant's co-pending patent application entitled REMOTE CONTROL WATER FLOW AND DRAIN SYSTEM, filed on the same filing date as this application. The entire specification of this co-pending application is incorporated herein by reference.

In one embodiment according to the present invention, a first pipe of a water impermeable material forms the water passage and extends along the side wall of the container, crossing the partition. The first pipe includes a lower end positioned in the proximity of the bottom of the container and an upper end connected to the hydro-electric connector attached to the container at the top thereof. A second pipe is provided for air breathing when water is introduced into or removed from the lower section of the container. The second pipe extends from the lower section to the top of the container and is in fluid communication with the lower section and the exterior atmosphere. The partition includes a plurality of apertures to permit water to flow therethrough, and optionally has means for delivering moisture by capillary action from the lower section to the upper section when soil is filled in the upper section and water is collected in the lower section of the container. This embodiment used with the flood and drain watering method ensures that the soil in the upper section of the container is saturated with water, and water not absorbed by the soil drains from the upper section of the container during each watering process. This embodiment also ensures that a pre-set volume of water not absorbed by the soil during the watering process is stored in the lower section of the container and is used to maintain soil moisture levels between watering processes.

In accordance with another aspect of the present invention, a plant container for growing plants includes a container having an open top, a closed bottom and a side wall extending from the bottom to the top. A partition is provided across the container to divide the container into an upper section for containing soil and a lower section for collecting water. The partition is adapted to permit water to alternately flow therethrough in both directions. A first pipe is provided in fluid communication with the lower section for alternately introducing water under pressure into the lower section and removing water under a vacuum action from the lower section. The first pipe is made of water impermeable material and extends along the side wall, crossing the partition. The first pipe includes a lower end positioned in the proximity of the bottom of the container and an upper end positioned at the top of the container. A connector is attached to the container and connected to the upper end of the first pipe. The connector is adapted for connection with the external water supply and withdrawal system to alternately introduce water into and remove water from the lower section in a controlled manner so that the flood and drain watering method can be applied to the plants growing in such a plant container. The container further includes a valve connected to an opening in the side wall of the container located immediately below the partition, for selectively draining excess water when the lower section of the container is already full of water. This is advantageous for the plant container to be used outdoors because there are no electric or electronic components to be exposed to rain and the container is adapted to drain excess water accumulated from rainfall.

In accordance with a further aspect of the present invention, a modular plant container for growing plants is provided. The modular plant container includes a first container having an open top, a closed bottom and a side wall extending from the bottom to the top. A partition is provided across the first container to divide the container into an upper section, and a lower section for collecting water. The partition has apertures to permit water to flow therethrough in both directions. A water passage is provided in fluid communication with the lower section and extends from the proximity of the bottom to the top of the first container for alternately introducing water under pressure into the lower section and removing water under a vacuum action from the lower section. The modular plant container further includes a plurality of spike members made of rigid water-absorbent material for delivering moisture under capillary action. The spikes extend upwards from the bottom of the first container through the partition and into the upper section. The combination of the spike members support the partition within the first container. A second container is provided for containing soil therein which is shaped and sized to fit into the upper section of the first container. The second container includes a first group of apertures in a bottom thereof corresponding to the apertures in the partition in order to permit water to flow therethrough. The second container further includes a second group of apertures for receiving the spike members passing therethrough when the second container is placed into the upper section of the first container. The modular plant container further includes an insert which has a plate and a plurality of sub-spikes extending upwards from the plate for forming holes in the soil contained in the second container when the sub-spikes are inserted into the second container through the spike member receiving apertures in the bottom thereof, and then soil is filled in the second container to bury the roots of the plant. The sub-spikes are sized and shaped to correspond to an upper portion of the spike members above the partition so that the second container with soil and a plant having roots buried therein is ready to be placed into the upper section of the first container after the insert is removed.

The second container and the insert are preferably made of a light and disposable material. Thus, the first container can be kept for permanent use and the second container with its insert can be sold with the plant growing therefrom separately from the first container.

The present invention advantageously provides an optimum non-spillage watering method. It is easy to observe when the top portion of soil in the pot is flooded with water if the water is introduced to the pot from the bottom to the top, thereby reducing the risk of water spillage. The soil flooded with water is fully saturated and the excess water not absorbed by the soil is easily completely removed from the pot, or partially removed with a selected volume of water left for maintaining moisture in the soil so that optimum and non-spill watering is achieved. This flood and drain watering method can be applied to market-available flower pots with easy modifications. Nevertheless, the plant containers in accordance with the present invention provide a convenient implementation of the flood and drain watering method and are particularly advantageous when used in combination with the REMOTE CONTROLLED WATER FLOW AND DRAIN SYSTEM in a fully programmable operation.

Other advantages and features of the present invention will be better understood with reference to preferred embodiments of the present invention described hereinafter.

### BRIEF DESCRIPTION OF THE DRAWINGS

Having thus generally described the nature of the present invention, reference will now be made to the accompanying drawings, showing by way of illustration the preferred embodiments thereof, in which:

FIG. 1 is an elevational cross-sectional view of a flower pot used for a flood and drain watering method according to the present invention;

FIG. 2a and 2b are alternative embodiments showing meshes in different shapes used to form a space at the bottom of the flower pot illustrated in FIG. 1;

FIG. 3a is a top plan view of a impermeable sheet used for sealing drainage holes of flower pots;

FIG. 3b is a perspective view of a tube of silicone glue used with the impermeable sheet shown in FIG. 3a for sealing drainage holes of flower pots;

FIG. 4 is a top plan view of the flower pot of FIG. 1, with the plant removed, showing one embodiment of the present invention with the water detecting device;

FIG. 5 is a schematic illustration showing a water flow and drain system with a flower pot according to another embodiment of the present invention for implementation of the flood and drain watering method;

FIG. 6 is an elevational cross-sectional view of the flower pot used in FIG. 5;

FIG. 7 is a partial cross-sectional view of the flower pot of FIG. 5, showing details of the spike members used in the flower pot;

FIG. 8a is a perspective view of the partition and spike member assembly used in the flower pot of FIG. 5;

FIG. 8b is a perspective view of an alternative embodiment of the partition and spike member assembly of FIG. 8a;

FIG. 9 is an exploded perspective view of a drop-in spike member assembly, showing a means for securing the partition and spike member assembly of FIG. 8a to the flower pot;

FIG. 10 is an elevational cross-sectional view of an outdoor flower pot used for implementation of the flood and drain watering method in accordance with a further embodiment of the present invention;

FIG. 11 is a perspective view of a modular flower pot used for the implementation of the flood and drain watering method in accordance with a still further embodiment of the present invention, a front portion of the modular flower pot being cut and removed in order to show the structural details therein;

FIG. 12 is a perspective view of the inner container of the modular flower pot of FIG. 11 with its insert, the front portion of the inner container and its insert being cut and removed in order to show the interior details of the inner container;

FIG. 13 is an exploded perspective view of a flower box used for the implementation of the flood and drain watering method in accordance with a still further embodiment of the present invention;

FIG. 14 is a perspective view of the inner container of the modular flower box of FIG. 13 with its insert, a front portion of the inner container and its insert being cut and removed in order to show interior details of the inner container;

FIGS. 15a, 15b and 15c are perspective views of flower pot hangers in various configurations for supporting the flower pots; and

FIG. 15d is a partial cross-sectional view taken along line 15-15 of FIG. 15b, showing the structural details of the hangers.

### DETAILED DESCRIPTION OF THE PREFERRED EMBODIMENT

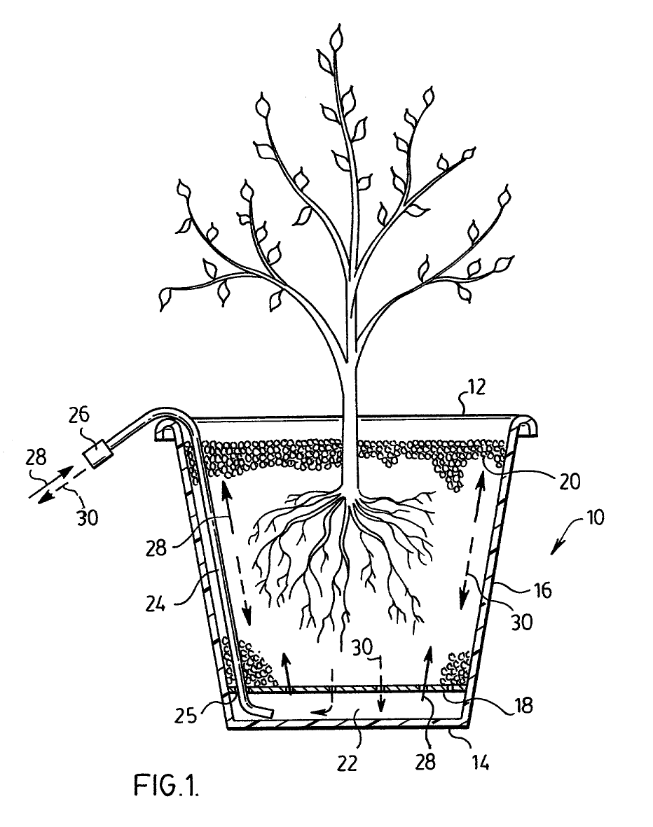

With reference to the drawings, particularly FIG. 1, a flower pot generally indicated at numeral 10, includes an open top 12, a closed bottom 14 and a side wall 16 which extends between the top and bottom in a truncated conical shape. A piece of mesh 18 is shaped and sized so that the mesh 18 fits into the flower pot 10 near the bottom 14 thereof and is supported by the side wall 16, being spaced apart from the bottom 14. In the flower pot 10, the mesh 18 separates the soil 20 in which the roots of the plant are buried, from the bottom 14 of the flower pot 10 to form a space 22 between the bottom 14 of the flower pot 10 and a bottom portion of the soil 20. The mesh 18 permits water to freely pass therethrough either downwards or upwards while inhibiting soil particulates from falling into the space 22. A pipe 24 which may be made of metal or hard plastic but is preferably made of a flexible, impermeable material extends from the space 22, passing through an opening 25 of the mesh 18 and upwardly along the side wall 16, further extending out of the open top 12 of the flower pot 10. A connector 26 is preferably provided at an outer end of the pipe 24 for connecting to a watering system or apparatus, without danger of being accidentally disconnected. The pipe 24 can be incorporated into the side wall 16 of the flower pot 10 and the connector 26 can be formed as a part of the side wall 16 at the open top 12 of the flower pot 10, to make it look neater. The space 22 should be of sufficient size to permit the collecting of water for pumping out.

The optimum watering of potted plants involves supplying sufficient water flow into the pot such that the soil can be saturated with the water while no excess water that cannot be absorbed by the soil, is allowed to remain in the pot. This optimum watering can be achieved by using the flood and drain watering method with a water supply and drainage apparatus or system, as described with in Applicant's co-pending patent application of REMOTE CONTROLLED WATER FLOW AND DRAIN SYSTEM.

For the flood and drain watering method, the outer end of the pipe 24 is to be connected to the water supply and drain apparatus or system, and the water is pumped through the pipe 24 into the flower pot 10 as shown by arrows 28. The water level in the flower pot 10 rises and reaches the top of the soil 20 so that the top portion of the soil 20 is flooded with water. This can be observed visually, detected by touch, or sensed by an electric water detector which could be a part of the flower pot 10 or an auxiliary probe. Details thereof will be further described below. When the water has reached the top 12 of flower pot 10 and the top portion of soil 20 has been flooded with water, the water supply must be turned off. A few seconds may be taken to ensure that all the soil 20 is totally saturated with water before the excess water, which is not absorbed by the soil 20 is pumped out of the space 22 of the flower pot 10, as illustrated by the arrows 30. The mesh 18 prevents soil particulates from being drained out with the water, and from clogging the pipe 24. The pipe 24 is preferably transparent to permit observation of the water removal process. Once water has been removed from the flower pot 10 the water removal process stops. Various sensors can be used to monitor the water supply and removal process in order to automatically control same. After water is removed and the removal process stops, more water may be collected in space 22 and can be further removed therefrom. Nevertheless, this will be only a relatively small amount of water accumulated in the space 22. This relatively small amount of water does not contact the soil 20 and may not cause any damage to the roots of the plant, and therefore it is optional to leave this small amount of water in the space 22 without a further removal process.

The flood and drain watering method can be easily applied to flower pots currently available in the market regardless of whether or not the flower pots have drain holes in the bottom thereof. A kit should be provided to allow a user to adapt the market available flower pots into the pots shown in FIG. 1 for the flood and drain watering method.

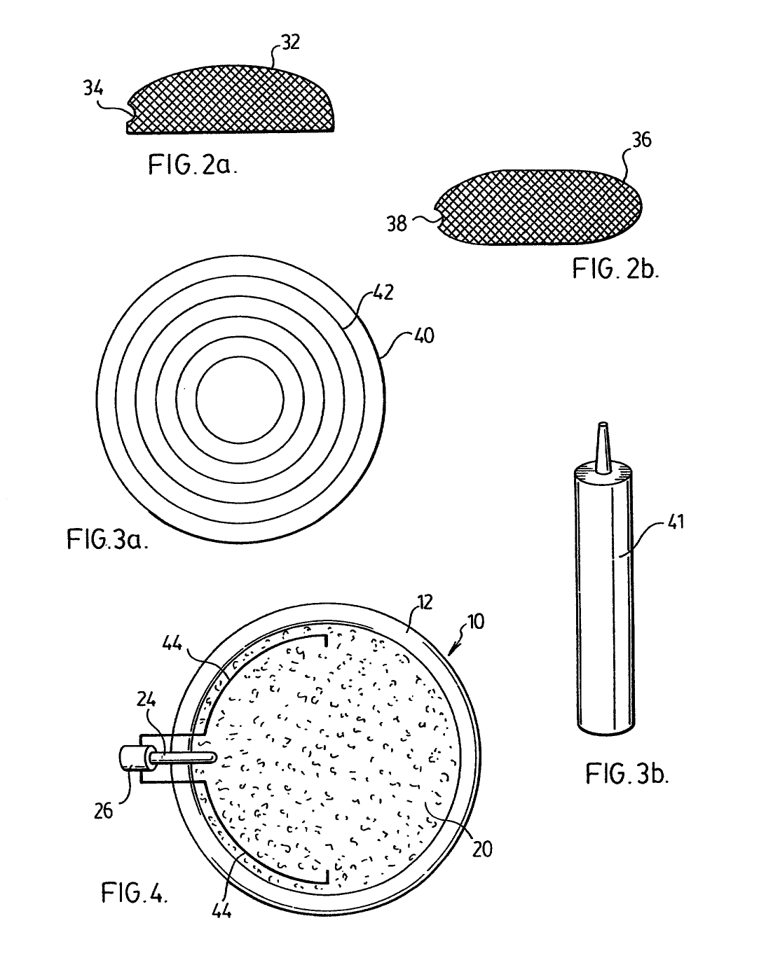

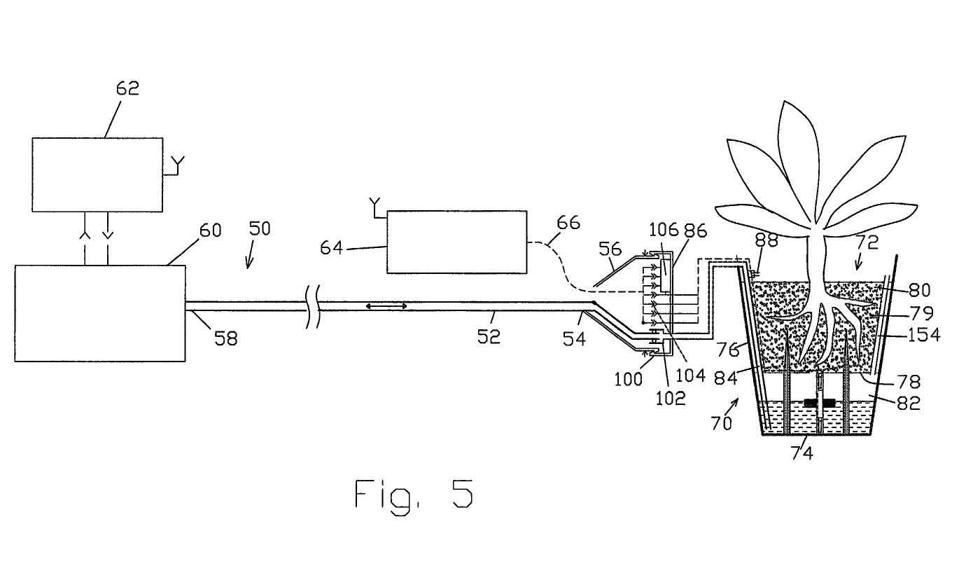

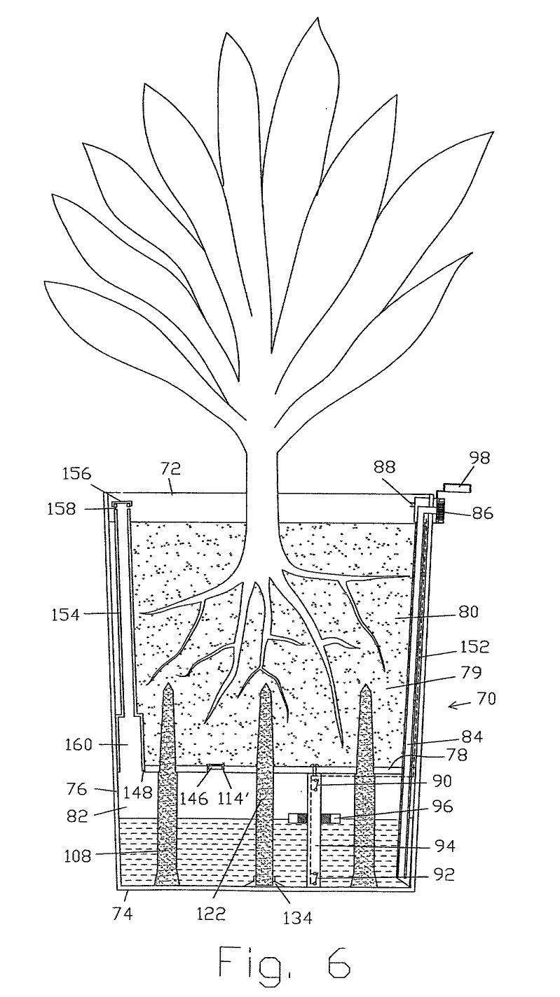

The kit for the flower pots without drain holes should include at least a flexible pipe of impermeable material to be used as the pipe 24 in FIG. 1 and a piece of mesh 18. The piece of mesh 18 could be a flat circular plate as shown in FIG. 1, but preferably is shaped as an inverted bowl 32 as shown in FIG. 2a with hole 34 for receiving the pipe 24, or as a full sphere 36 as shown in FIG. 2b with a hole 38 for receiving the pipe 24. The mesh 32 and 36 are advantageously preformed and can be used in different sizes of flower pots. However, the flat circular plate mesh 18 as shown in FIG. 1 has to be cut on site in a size and shape, to fit individual flower pots 10. The kit preferably further includes a connector 26 as shown in FIG. 4 and insulated wires 44 to be used as a simple moisture detector.

The kit should further include a circular sheet 40 made of an impermeable material, as shown in FIG. 3a, such as rubberized material and sealing materials, such as a pipe 41 of silicone, as shown in FIG. 3b, if the kit is to be used with flower pots having holes at the bottom.

The process of converting the currently available flower pot with a plant therein into a flower pot 10 as shown in FIG. 1, suitable for the flow and drain watering method can be completed by using the kit provided. First, the plant and the soil 20 therewith are removed from the flower pot 10 and the flower pot 10 is thoroughly washed and dried.

If there are drainage holes in the bottom 14 of the flower pot 10, sealing the drainage holes is necessary. The rubberized sheet 40, shown in FIG. 3a, should be cut to a size and shape that will properly cover the bottom 14 of the flower pot 10. Preferably, the rubberized sheet 40 has printed rings or circular grooves 42 for easy cutting. The silicone from the pipe 41 is then applied around the bottom 14 of the flower pot 10 and then the rubberized sheet 40 is placed on the bottom 14 of the flower pot 10 to seal the drainage holes (not shown) in the bottom 14 of the flower pot 10.

If the flower pot 10 has a closed bottom 14 without holes, the steps for sealing the bottom 14 of the flower pot 10 are omitted.

The flexible pipe 24 is cut to a size so that the connector 26 at the outer end of the pipe 24 is positioned to extend a few centimeters over the top 12 of the flower pot 10, and the pipe 24 runs at the side wall 16 to the center of the bottom 14 of the flower pot 10. The piece of mesh 18 is placed near the bottom 14 of the flower pot 10 to form the space 22, with the pipe 24 running into the space 22 through the opening 25 of the mesh 18. A small portion of soil 20 is removed from the bottom of the plant and then the plant and the remainder of the soil 20 therewith are placed back into the flower pot 10 on top of the piece of mesh 18. The two insulated wires 44, as shown in FIG. 4, are buried on opposite sides of the top portion of the soil 20 one half inch under the top surface. Each insulated wire 44 has the insulation material removed at the end which is buried in the soil 20 and the other end is connected to an electrical resistance measuring circuit (not shown) which is part of an automatic controller (not shown) of the water supply and removal apparatus or system, so that when the top portion of the soil 20 is flooded with water the wires 44 electrically connect and the electrical resistance measuring circuit sends a signal to stop the water supply process. The connector 26 preferably includes electrically conductive contacting means so that the connector 26 not only connects the pipe 24 in fluid communication with a pipe of the water supply and removal apparatus but also electric-conductively connects the wires 44 to a pair of conductors of the water supply and removal apparatus or system (not shown).

The flood and drain watering method can be used with a water supply and removal apparatus or system, using various types of sensors to monitor the water supply and drain process automatically. The wires 44 in FIG. 4 connected with the electrical resistance measuring circuit are just one simple example. Other types of moisture sensors can be used to automatically stop the water supply process and begin a water removal process. A timer (not shown) can also be used to control the water removal process to begin after a short waiting period, for example, 30 seconds in order to ensure that the soil 20 has time to be completely saturated with water.

The flood and drain watering may be automatically controlled completely by timers. For example, water supply can be conducted for 10 seconds and after a 30 second waiting period, the water removal process is conducted for a further 5 seconds. However, the timers have to be programmed according to the results of a set-up test conducted for those particular flower pots 10.

A water detector may be included in the water supply and removal apparatus or system to automatically stop the water removal process when no more water can be removed from the flower pot 10. This method could be even further simplified by recording the amount of water which was used during the set-up. Water meters are used in the water supply and removal apparatus or system to measure the water volume supplied or removed, and to stop the procedure when the measured volume of water matches the recorded amount of water used during the set-up period.

In both the volume and time control methods, the maximum allowed flow should be determined for each flower pot 10 during the initial set-up period. It is suggested that this value determined in the initial set-up should be then reduced to roughly 75% of the amount used in the set-up period in order to prevent over-spill. This value should be stored in a control system for each individual flower pot 10 in order to make the watering procedure as safe and easy as possible. All the affected flower pots 10 in a household should be numbered by some well known numbering means. Whenever manually initiated watering is conducted the identification number of each flower pot 10 should be entered into the control system and the value for the maximum safe water flow for the identified flower pot 10 will be automatically used. If other flower pots 10 in a household are connected to a water supply and drainage system the same watering sequence is used each time. An automatic watering of the other flower pots 10 in the household can be achieved by automatically initiating watering of another flower pot 10 upon completing the watering of one flower pot 10 in a numbering sequence which is predetermined and stored in the control system.

Another possibility for automatic watering control is that a moisture change control method can be combined with a water volume control method, which can be achieved by using either timers or water meters. However, the maximum safe water flow used to water each individual flower pot 10 can only be approximately 10% more than the maximum allowed flow, as determined during the set-up procedure. This method is safer because if the moisture detector does not work properly or is pulled out by accident, the timer or the water meter will act as a backup system and will stop the water supply when the maximum amount of water has been delivered, thereby avoiding water spillage.

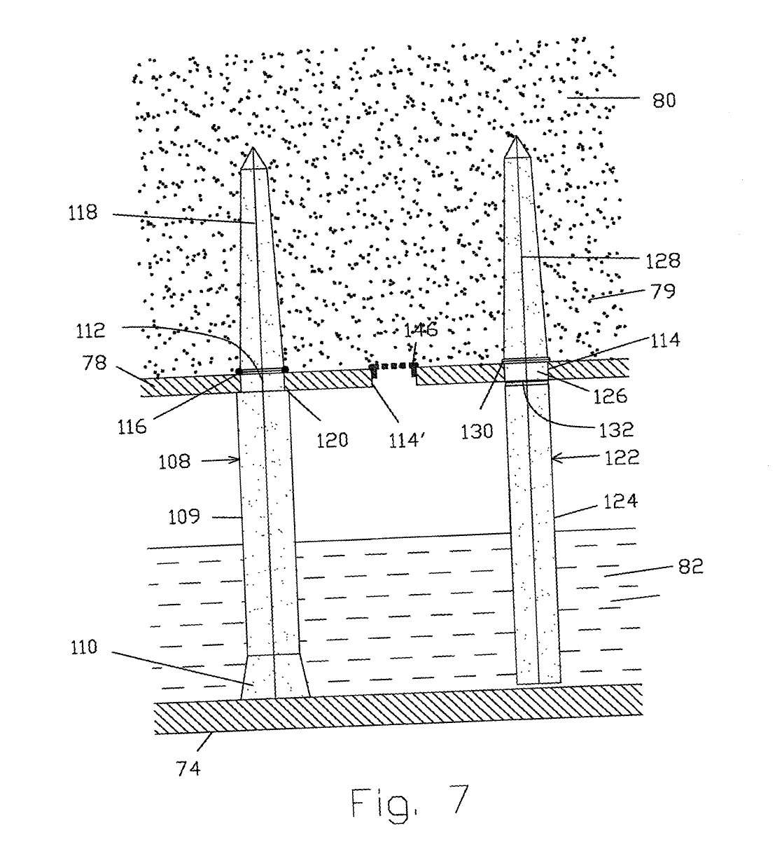

FIG. 5 illustrates the implementation of the flood and drain watering method with a water flow and drain system, generally indicated by numeral 50 and a flower pot 70 in accordance with another embodiment of the present invention. The water flow and drain system 50 is described in the Applicant's co-pending patent application of REMOTE CONTROL WATER FLOW AND DRAIN SYSTEM and will be briefly described for its function in the flood and drain watering of the flower pot 70 which is illustrated with details in FIG. 6. Therefore, reference is also made to FIG. 6 in the description below.

The water flow and drain system 50 includes a single water pipe 52 having one end 54 adapted for connection with the flower pot 70 by means of a hydro-electric connector 56, and having the other end 58 connected to a hydro-electrical system 60 which also includes a water source and a place for water drainage. The hydro-electrical system 60 is electrically connected to a main controller 62 so that water can be supplied to the flower pot 70 and can be withdrawn from the flower pot 70 in a required amount through the single water pipe 52, during different periods of time. During operation, the main controller 62 signals the hydro-electrical system 60 to switch water communication modes of the water pipe 52 at the end 58 to either communicate with a water source or a with place for water drainage. The main controller 62 also signals a pump of the hydro-electrical system 60 to alternately pump water from the water source through the water pipe 52 to the flower pot 70, and to generate a vacuum action to withdraw water from the flower pot 70 through the water pipe 52 which delivers the water to the place for drainage, in a controlled sequence.

The main controller 62 can be manually operated to signal the hydro-electrical system 60 to supply water from the water source to the flower pot 70 in a required amount at one time, and to signal the hydro-electrical system 60 to withdraw a required amount of water from the flower pot 70 and deliver the required amount of water to the place of drainage at another time. However, this operation can also be done automatically by the main controller 62 in response to signals sent from a remote controller 64 which is positioned in the proximity of the flower pot 70. The remote controller 64 can be electronically connected to the main controller 62, either wirelessly or through cable connection, as shown by broken line 66 (see FIG. 5). The main controller 62 may also receive signals from sensors in the flower pot 70, which will be further described with details below.

The flower pot 70 which is intended for use indoors, includes an open top 72, a closed bottom 74 and a side wall 76 which extends from the bottom 74 to the top 72 in a truncated conical shape. A perforated partition 78 across the flower pot 70 divides the same into an upper portion 79 and a lower portion 82. The upper portion 79 is used for containing soil 80 in which the roots of the plant are buried. The lower portion 82 is formed as a reservoir for containing water in the flower pot 70. The perforated partition 78 permits water to freely pass therethrough, either downwardly or upwardly, while inhibiting soil particulates from falling into the lower section 82. A pipe 84 in fluid communication with the lower section 82 extends from the proximity of the bottom 74, passing through the perforated partition 78 and upwardly along the side wall 76 to the top 72. An upper end of the pipe 84 extends out of the open top 72 of the flower pot 70 and is provided with a hydro-electric connector 86 which is attached to the outer surface of the side wall 76 at the top 72, as shown in FIG. 6. The hydro-electric connector 86 schematically illustrated in an enlarged scale in FIG. 5 however, is detached from the flower pot 70 for a better illustration of a connection with the corresponding hydro-electric connector 56 of the water flow and drain system 50.

A water level detector 88 is positioned near the top 72 of the flower pot 70, attached to the inner surface of the side wall 76 so that the water level detector 88 can generate and transmit an electric signal when the top of the soil 80 is flooded with water. Switches 90 and 92 are provided in the lower section 82 of the flower pot 70 and are supported by an elongate support member 94 which vertically extends between the bottom 74 and the partition 78. Switch 90 is positioned immediately beneath the partition 78 and the switch 92 is positioned at the bottom 74 of the flower pot 70. Both switches 90, 92 can be magnetically activated. A float member 96 having a magnet with a central hole surrounds the elongate support member 94 and floats on the surface of the water collected in the lower section 82 of the flower pot 70. The float member 96 moves up or down to selectively activate the switches 90, 92 when the water level in the lower section 82 changes. When no water or very little water exists in the lower section 82, only switch 92 will be activated and when the lower section 82 is full or almost full of water, only switch 90 will be activated. Neither switch 90 nor switch 92 are activated when a moderate volume of water remains in the lower section 82 of the flower pot 70, as shown in FIG. 6.

The switches 90 and 92, as well as the water level detector 88 are electrically connected to the hydro-electric connector 86 which is adapted for hydroelectric connection with the hydro-electric connector 56 of the water flow and drain system 50. The hydro-electric connector 86 has a mechanical interlocking member 100 for releasably interlocking with the corresponding member of the hydro-electric connector 56, and is connected to the top end of the pipe 84 with a sealing device 102 to provide a water-tight connection of the water pipe 84 of the flower pot 70 with the water pipe 52 of the water flow and drain system 50 when the hydro-electric connectors 56, 86 are interlocked together. Metal contacts 104 are also provided on the respective hydro-electric connectors 56, 86 so that the water level detector 88 and switches 90, 92 (see FIG. 6) will be electrically connected to the water flow and drain system 50 when the hydro-electric connectors 56, 86 are interlocked together. A memory chip 106 is preferably provided within the hydro-electric connector 86 and includes identification information of this flower pot 70 to be used by the water flow and drain system 50. A removable cap 98, as shown in FIG. 6, is preferably attached to the hydro-electric connector 86 for covering the connector while the hydro-electric connector 56 of the water flow and drain system 50 is disconnected and removed from the hydro-electric connector 86 of the flower pot 70, in order to protect the seal device 102, metal contacts 104 and the memory chip 106. The hydro-electric connectors 56 and 86 facilitate a quick connection of the flower pot 70 to the water flow and drain system 50, thereby permitting passage of water both ways and passage of electric signals from the flower pot 70 to the water flow and drain system 50. The hydro-electric connectors 56 and 86 mechanically interlock with each other so that they cannot be accidentally separated. An electric interlock which allows passage of water only when two connectors 56 and 86 are mechanically interlocked is also provided with the water flow and drain system 50 so that water flow will immediately stop if the mechanical interlock is broken.

Referring now to FIGS. 6, 7 and 9, the flower pot 70 further includes watering spikes 108 which are made of water absorbent, porous material, such as baked clay-brick with an optional wick built therein. A lower portion 109 of the watering spikes 108 sit in the water if a volume of water is collected in the lower section 82 of the flower pot 70 and an upper portion 118 of the spikes 108 extend into the soil 80 contained in the upper section 79 so that watering spikes 108 move water under capillary action from the reservoir 82 to the soil 80.

Different designs of watering spikes 108 are possible. The watering spikes 108 in this embodiment have a cylindrical shape at the lower portion 109 and have a wider bottom end 110 for better stability as they rest on the bottom 74 of the flower pot 70. The watering spikes 108 have a narrower neck 112. Because the watering spikes 108 have to be attached to the partition 78 in such a way that the watering spikes 108 do not fall, the neck 112 of each watering spike 108 is sized to snugly fit into the hole 114 of the partition 78. Alternatively, a groove (not shown) may be provided above the neck 112 to engage a retaining washer or spring 116. The upper portion 118 is conical so that the watering spike 108 can be easily inserted into and if necessary, removed from the soil 80. The partition 78 rests on the shoulder 120 formed between the cylindrical lower portion 109 and the neck 112 when the watering spike 108 is used to support the partition 78 in the flower pot 70.

The flower pot 70 may further include another type of watering spikes 122 in a drop-in design. The watering spike 122 is made of the same material as that of watering spike 108 and performs the same water delivery function under capillary action as the watering spike 108. However, the watering spike 122 has a cylindrical lower section 124 which has a diameter thereof equal to or slightly smaller than the diameter of the neck portion 126 so that the watering spike 122 can be easily inserted through the hole 114 in the partition 78 from above. The watering spike 122 has a conical top portion 128 and a ridge 130 is provided between the neck portion 126 and the conical upper portion 128 to prevent the watering spike 122 from falling through the hole 114, when the partition 78 is lifted. An annular groove 132 is provided between the neck portion 126 and the lower portion 124, beneath the partition 78 so that a retaining washer or spring (not shown) can be received therein to further restrain movement of the watering spike 122 relative to the partition 78. This type of watering spike 122 is used when the partition 78 is supported by a ledge (not shown) of the flower pot 70, or as additional spikes to increase the amount of moisture delivered into the soil 80.

It is desirable that the partition 78 be secured to the flower pot 70 to ensure that the partition 78 with the watering spikes 108 and 122 will stay in place when the plant is being removed from the flower pot 70 and will prevent the soil 80 and plant from being lifted from the flower pot 70 when water is supplied through the water pipe 84 into the lower section 82 thereby exerting upward pressure on the partition 78 and the soil 80 during a watering process. The partition 78 can be affixed by any well known means (not shown) to the side walls of the flower pot 70.

In accordance with a preferred embodiment shown in FIGS. 6, 8a and 9, at least one drop-in spike 122 is releasably secured to the bottom 74 of the flower pot 70 by means of an interlock device 134. The interlock device 134 includes a shoe 136 which is a sleeve member with two keys 138 extending radially and outwardly from the bottom of the shoe 136, and a base socket 140 having a central aperture 142 and two keys 144 positioned within the aperture 142. The shoe member 136 and the base socket 140 are secured to the respective lower section 124 of one of the watering spikes 122 and the bottom 74 of the flower pot 70, for example, by adhesive. Thus, after the partition 78 is assembled with the watering spikes 108 and 122, the assembly is lowered into the flower pot 70 and the watering spike 122 which has the shoe member 136 is inserted into the base socket 140 and then rotated to interlock the shoe member 136 and the base socket 140. The keys 144 on the base socket 140 have a stopper at one end thereof which can be seen in FIG. 9, in order to prevent the shoe member 136 from being over-rotated, and therefore the engagement of keys 138 and 144 is ensured. The shoe member 136 and the base socket 140 can be made, for example, of plastic pieces.

The combination of the two types of watering spikes 108 and 122 advantageously provides not only support to the partition 78 within the flower pot 70, but also provides a moisture adjustment mechanism to the flower pot 70. The amount of moisture drawn from the reservoir formed by the bottom section 82 of the flower pot 70 into the soil 80 by the capillary action of the watering spikes 108, 122, is proportional to the number of watering spikes 108 and 122, and therefore can be adjusted by selection of the total number of the watering spikes 108 and 122, which can be conveniently conducted by increasing or reducing the number of the drop-in watering spikes 122.

The absorbent and porous watering spikes 108 and 122 which may optionally include wicks extending therein, can lift water moisture under capillary action significantly higher in comparison with conventional ribbon wicks. Therefore, the reservoir formed by the lower section 82 of the flower pot 70 can be made relatively higher, which will extend the interval between watering processes.

The partition 78 is made of material, such as fiberglass, aluminium or plastic that can carry the weight of the soil 80 and the plant. The partition 78 includes the holes 114 through which the watering spikes 108 and 122 can be inserted from the bottom or from the top, respectively. The partition 78 also includes provision for passage of water in both directions through the partition 78 which can be small holes made directly in the partition 78, or relatively large holes made in the partition, each covered with mesh.

In accordance with this embodiment, the partition 78 includes a plurality of relatively large holes 114′, each closed with a perforated plug 146. The size of holes 114′ is equal to the size of holes 114 so that a number of holes 114 can be selected for receiving the watering spikes 108 and 122 depending on the type of plant, and the unused holes 114′ are simply closed with the perforated plugs 146. This configuration also makes the manufacturing process easier since only relatively large holes of one uniform size need to be produced. The perforated plugs 146 can be made of plastic material at low cost.

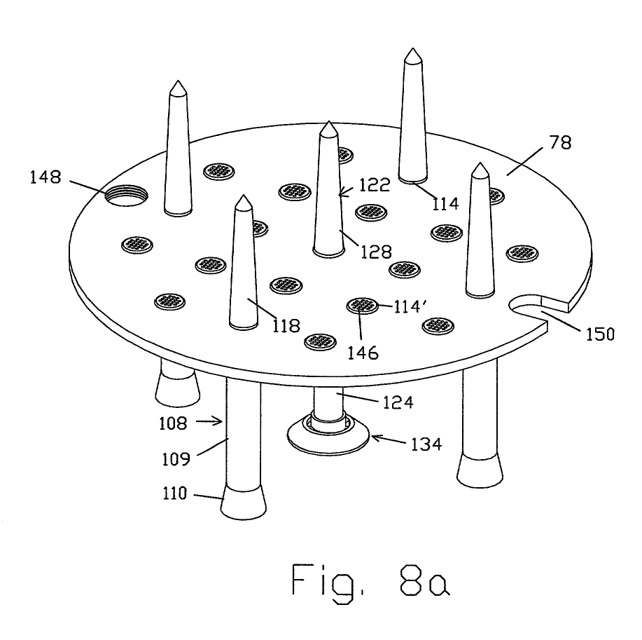

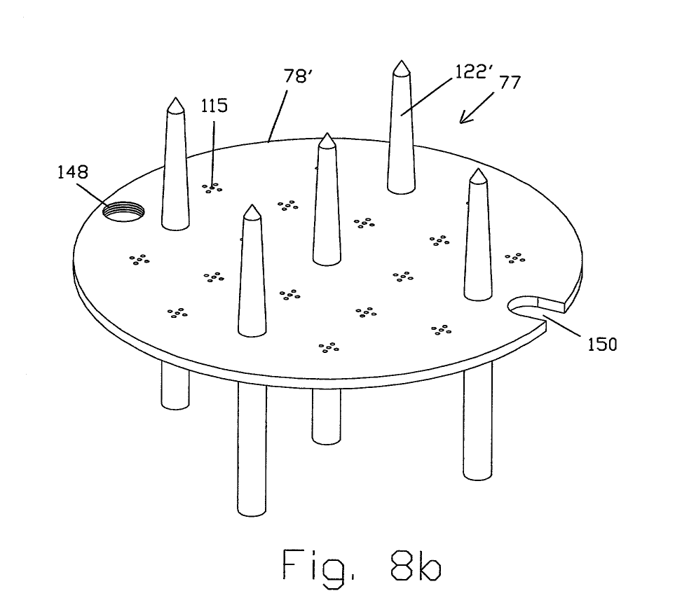

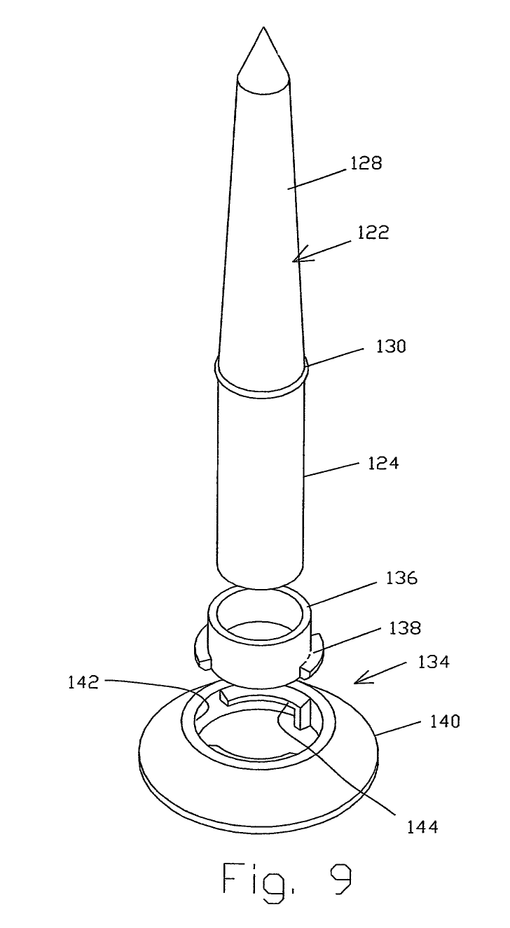

The partition 78 further includes holes 148 or recesses 150 at opposed sides thereof, respectively. FIG. 8a illustrates one hole 148 and one recess 150 at the respective sides, which is just an exemplary illustration. In FIG. 8a, the recess 150 is for receiving the water pipe 84 and insulated wires 152 (see FIG. 6) which electrically connect the switches 90, 92 and the hydro-electric connector 86, passing therethrough. The hole 148 at the other side of the partition 78 is for receiving a breathing pipe 154 of FIGS. 5 and 6, which will be further described below.

FIG. 8b illustrates a partition and spike assembly 77 in accordance with an alternative embodiment of the invention. The assembly 77 includes a partition 78′ and a plurality of spike members 122′ which are similar to partition 78 and spikes 122 of FIG. 8a, but are made in one piece, for example, baked clay. The partition 78′ includes hole 148 and recess 150 at opposed sides thereof. Relatively small holes 115 are provided in groups and extend through the partition 78′ to replace the holes 114′ closed with the perforated plugs 146 of FIG. 8a.

The partition and spike assembly 77 made of baked clay in one piece is easy to manufacture with relatively low costs. The one-piece assembly can also be conveniently used with an ordinary flower pot for a conventional watering procedure, creating a water reservoir in the flower pot and generating a capillary action to moisten the soil in the flower pot after the conventional watering.

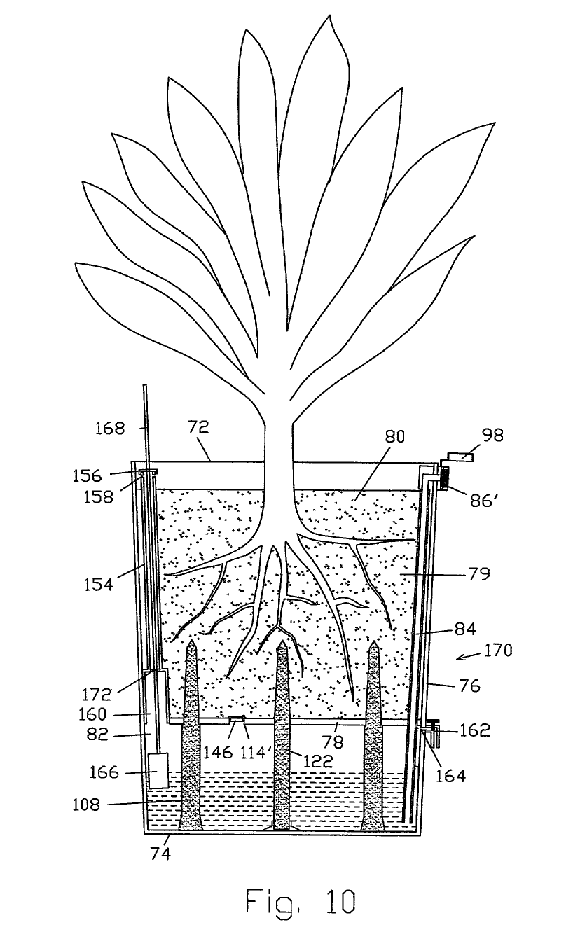

As is more clearly shown in FIG. 6, the breathing pipe 154 which is in fluid communication with the lower section 82, is received in the hole 148, extends upwards along the side wall 76 of the flower pot 70 and protrudes through the soil 80, terminating above the top of soil 80 with a cap 156. There are a plurality of holes 158 perforating the breathing pipe 154, being spaced apart around the breathing pipe 154, and situated just below the cap 156. When the water is introduced into or removed from the lower section 82 through the water pipe 84, the breathing pipe 154 allows air to pass in and out of the lower section 82. The breathing pipe 154 may include an enlarged lower portion 160 which will be described further with reference to FIG. 10.

Referring to FIGS. 5 and 6, a flood and drain watering process for the flower pot 70 is briefly described below as an example of the flower pot 70 to be used in the implementation of the flood and drain watering method of the present invention. In order to ensure that the flood and drain watering process of house plants is efficient, safe and automatic, a number of parameters have to be determined and stored in the main controller 62 of the water flow and drain system 50 for each particular flower pot 70. These parameters include total volume of the flower pot, volume of the reservoir, volume of water necessary to saturate the soil, flow rate of water feeding the reservoir, flow rate of water flooding the soil, time delay to allow soil to absorb the water, amount of water that has to be removed, draining rate for removing the water, and number of days to next watering. Most of the parameters can be determined automatically by the water flow and drain system 50 while the watering process is conducted for the first time and is manually controlled by the operator.

In order to make the system simpler, the flower pots 70 are coded when they are manufactured. For example, the flower pots 70 are coded with a single letter to provide the size information thereof. Generally, no more than two dozen different sizes of flower pots 70 will be expected. This code is marked on the flower pot 70 and preferably is also permanently stored in the memory chip 106 that is built into the hydro-electric connector 86 attached to the flower pot 70. The memory chip 106 in the hydro-electric connector 86 also contains a randomly selected high digit number of, for example, ten digits. This number is used in the water flow and drain system 50 to identify the individual flower pots 70 which are maintained in one household and are served by the same system.

When the hydro-electric connector 86 of the flower pot 70 is interlocked with the hydro-electric connector 56 of the water flow and drain system 50 for the first time, the size information and identification number stored in the memory chip 106 of the connector 86 is read through the remote controller 64 and electronically transmitted to the main controller 62. Because the high digit identification number for this flower pot 70 is different from all others, the main controller 62 will assign a number, a character or a name to the particular flower pot 70 and the number, character or name will be displayed on the remote controller 64. A sticker or flag with this number, character or name should be attached to this flower pot 70.

Water supply is initiated by pressing a corresponding button on the remote controller 64 and the system 50 then supplies the water at a standard rate that is stored in the main controller 62 for the coded type of this flower pot 70, through the hydro-electric connectors 56, 86 and the water pipe 84 of the flower pot 70 to the lower section 82 of the flower pot 70. The floater 96 rises up as the water level rises in the lower section 82 of the flower pot 70. When the water level of the lower section 82 is high enough to move floater 96 close to switch 90, switch 90 is activated and sends an electric signal to the system 50. Upon receipt of the signal sent by switch 90 the system 50 then supplies water at a new rate which is slower, to prevent potential spillage when water enters the upper section 79 through the perforated plugs 146 in the holes 114′ of the partition 78 to flood the soil 80.

Water in the breathing pipe 154 will rise as water rises into the upper section 79 of the flower pot 70. However, the water level in the breathing pipe 154 rises higher than the water level in the upper section 79 because the soil 80 damps the water flow. Water in the breathing pipe 154 will reach the top and run out of the holes 158 below cap 156 before the top of the soil 80 is flooded by water. the water from the holes 158 of the breathing pipe 154 runs over the surface and is absorbed by the soil 80. After a short period of time, the soil 80 cannot absorb any more water and the water starts rising above the surface of the soil 80.

When the water level reaches the water detector 88, the system 50 receives an electric signal from water detector 88 to stop the water supply, and waits for a short period of time for the water to be properly absorbed by the soil 80. After the predetermined short period of time has expired, the system 50 begins to withdraw water from the flower pot 70 through the water pipe 84 at a predetermined draining rate for the coded type of this flower pot 70. When the water level drops below the level of switch 90 and thereby allows the floater 96 to lower, deactivating switch 90, the water removal is stopped. A volume of water is left in the lower section 82 but the water level is not high enough to be in direct contact with the soil 80 contained in the upper section 79.

The water left in the lower section 82 after the watering process is completed is used for maintaining moisture in the soil 80 between watering processes. Moisture is lifted through the watering spikes 108 and 122 by capillary action and is delivered into the soil 80, and the water volume in the lower section 82 of the flower pot 70 is thereby gradually reduced. Ideally, the water volume in the lower section 82 will be reduced to zero about the time the next watering process should begin.

The first watering operation must be observed and can be adjusted as desired by the operator, using the remote controller 64. The newly adjusted values will replace the preset parameters which are standard for all flower pots coded with that same letter and will be stored in the main controller 62 of the system 50 for this particular flower pot 70. The exact volume of water from switch 90 to the water level detector 88 is also stored in the main controller 62 for this flower pot 70. The system 50 will give warning or alarm when a predetermined time period between waterings has elapsed.

During a normal watering process other than the first time watering process and the watering processes in which an adjustment needs to be made manually, the hydro-electric connector 86 of the flower pot 70 is first interlocked with the hydro-electric connector 56 of the system 50. The remote controller 64 of the system 50 then reads the memory chip and after identifying the flower pot 70 as one that has already been serviced, tests the state of the switch 92. If switch 92 is not activated, which indicates that there is still water in the lower section 82 of the flower pot 70 above the switch 92, the system 50 will automatically increase the time period to the next watering. This way system 50 can automatically determine the longest possible time interval between watering processes.

The water flow and drain system 50 starts supplying and draining the water according to parameters stored in the main controller 62 for this particular flower pot 70. However, different volumes that are stored in the main controller 62 for this particular flower pot 70 are not used to directly control the watering process, but are used as safety backups. If any of the switches or detectors fail, the amount of water will be generally limited to the volume stored in the main controller 62. Therefore, spillage is prevented.

In FIG. 10, a flower pot 170 in accordance with another embodiment of the present invention is an outdoor flower pot basically similar to the flower pot 70 of FIG. 6 which is intended for use indoors, with a few differences. The main concern with the flower pot 70 is that there will be no water spills during the watering processes. This requirement however, is somewhat relaxed for outdoor potted plants. On the other hand, electrical and electronic components are not desirable for use with the outdoor flower pot 170 because exposed electrical contacts will corrode very quickly outdoors. Therefore, the flower pot 170 does not include the water level detector 88, switches 90, 92, floater 96, elongate member 94 and wires 152 which are included in the flower pot 70 of FIG. 6. The hydro-connector 86′ replaces the hydro-electric connector 86 of the flower pot 70 of FIG. 6, and only provides a sealing connection to the water pipe 52 of the system 50 through the hydro-electric connector 56 of the system 50 of FIG. 5. The components of the flower pot 170 similar to those of flower pot 70 shown in FIG. 6 are indicated by similar numerals and will not be redundantly described.

In order to maintain the simplicity of the outdoor flower pot 170 and prevent over-watering, new components and features are introduced. A relief valve 162 is provided to selectively close an opening in the side wall 76 positioned immediately below the partition 78. The relief valve 162 normally remains opening between watering processes so that excess water which is not absorbed by the soil 80 and has been collected in the flower pot 170 resulting from rainfall will drain through the relief valve 162 and thereby the water level in the flower pot 170 will remain below the partition 78. The relief valve 162 should be closed while a flood and drain watering process is being conducted.

A float member 166 with a stick 168 extending upwards therefrom is provided to indicate the water level in the lower section 82 of the flower pot 170. The stick 168 extends from the float member 166, through the breathing pipe 154, out of an aperture (not shown) of the cap 156 and protrudes above the top 72 of the flower pot 170, so that the length of the stick 168 above the top 72 of the flower pot 170 indicates the water level in the lower portion 82 of the flower pot 170. The enlarged lower section 160 of the breathing pipe 154 allows the float member 166 to rise to a level above the partition 78. Thus, the stick 168 is also adapted to indicate that the water level has risen to a level within the upper section 79 of the flower pot 170, which means the bottom portion of soil 80 has been flooded with water. Stick 168 is preferably provided with indication marks on its upper section, which correspond to the water level in the flower pot 170. A guide member 172 is preferably inserted into the breathing pipe 154 for guiding the stick 168 in its reciprocation within the breathing pipe 154 while permitting air and water to pass therethrough.

When the plant in the flower pot 170 is watered for the first time, the water flow and drain system 50 of FIG. 5 is in a programming mode and the type and number of the flower pot 170 should be manually input into the system 50. The type and number of the flower pot 170 are also marked on the flower pot 170 when it is manufactured. The automatic control of the watering process of outdoor flower pot 170 is different from the automatic control of the watering process of indoor flower pot 70 because the outdoor flower pot 170 does not have water level sensing devices shown in FIG. 6, and therefore the control is based on water volume.

After the identification information is input into the water flow and drain system 50 of FIG. 5, and the watering process is manually initiated with the remote controller 64 of the system 50, the system 50 begins by removing water from the flower pot 170. First, any water that is has collected in the lower section 82 of the flower pot 170 will be removed through the water pipe 84 of the flower pot 170 until no more water can be removed from the water pipe 84. This condition can be detected by the system 50 of FIG. 5. The system 50 then supplies water at a predetermined rate to the lower section 82 of the flower pot 170, through the water pipe 84. After a predetermined amount of water which substantially fills the lower section 82 of the flower pot 170 is supplied, water flow into the flower pot 170 is changed to a predetermined lower rate of flow. At this lower flow rate, a predetermined amount of water is supplied, to saturate the soil 80 in the flower pot 170 and then the water flow is turned off. After a period of time to permit the soil 80 to absorb water, the system 50 of FIG. 5 begins to drain a predetermined amount of water. After the predetermined amount of water has been removed from the flower pot 170, a volume of water left in the lower section 82 of the flower pot 170 should be at a level slightly below the partition 78 for further moistening of the soil 80 through the watering spikes 108, 122 between watering processes.

All predetermined amounts of water and water flow rates are selected from parameters pre-set in the system 50 of FIG. 5, according to the input type code of the flower pot 170. However, the watering process of the first time must be manually observed, and can be manually adjusted using the remote controller 64 if any changes are desired. Those changes will be entered into the system 50 of FIG. 5 and will replace the relative pre-set parameters of this particular flower pot 170.

The normal watering process of the plant in the outdoor flower pot 170 is similar to the watering process described for the first time. However, at the beginning of the process the system 50 of FIG. 5 removes water left in the lower section 82 of the flower pot 170 and measures the volume of the water being removed. If the amount of removed water is more than 10% of the capacity of the lower section 82 of the flower pot 170, the system 50 will automatically increase the time period to the next watering. Thus, when the system 50 gives warning or alarm for the next watering process, there should be no water left in the lower section 82 of the flower pot 170, provided that there are no unusual amounts of rainfall between watering processes.

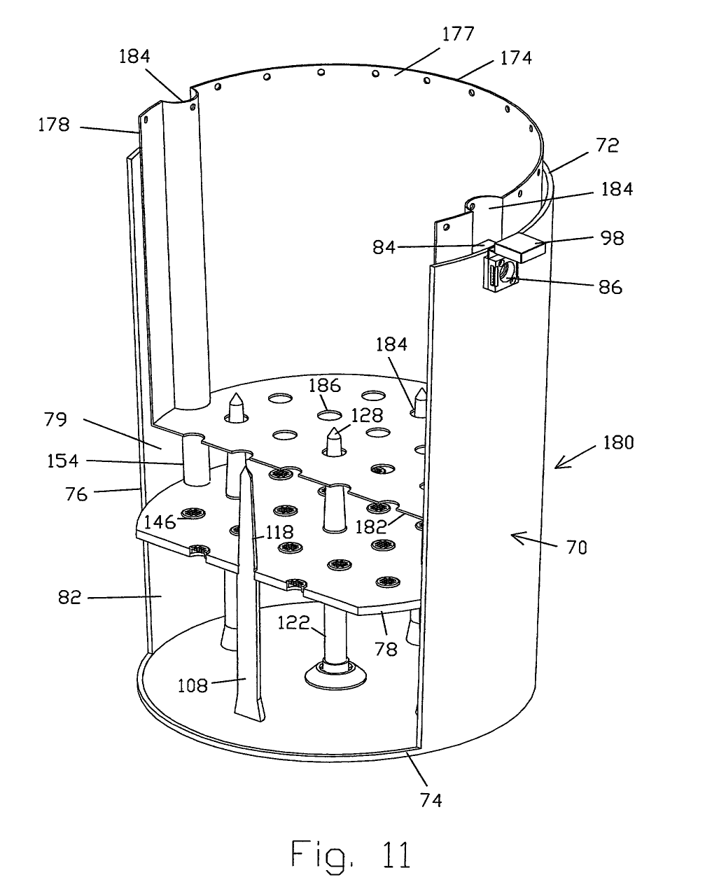

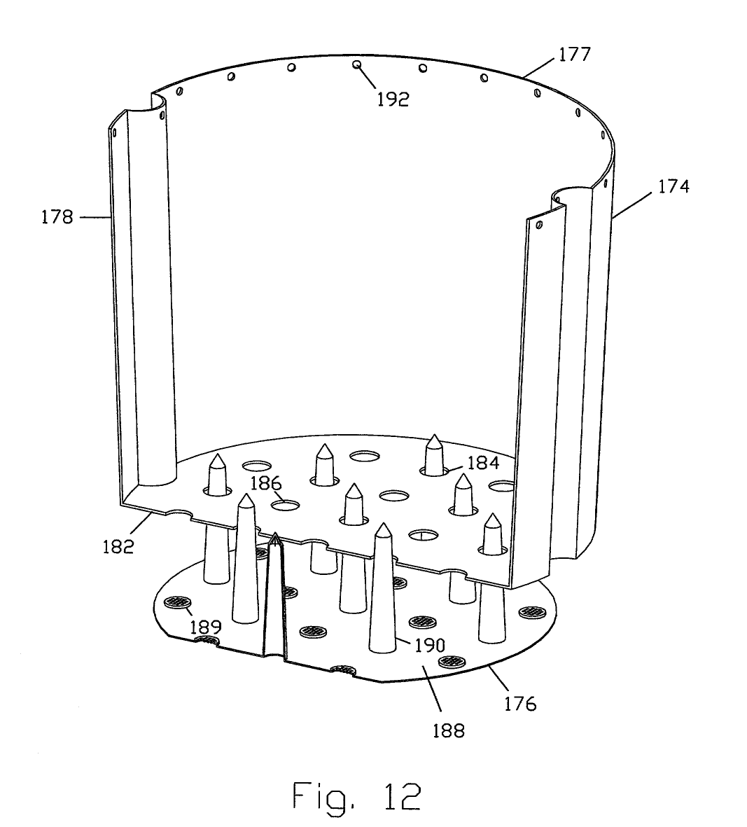

In FIG. 11 a modular flower pot 180 according to a further embodiment of the present invention is provided for use in the implementation of the flood and drain watering method for potted plants. The modular flower pot 180 is similar to the indoor flower pot 70 of FIG. 6 or the outdoor flower pot 170 of FIG. 10, except for an additional inner container 174 and a disposable insert 176 which are illustrated in FIG. 12. As an example, the modular flower pot 180 illustrated in FIG. 11 is similar to the indoor flower pot 70 of FIG. 6 and similar components and features indicated by similar numerals will not therefore, be redundantly described. The switches 90, 92, float 96, elongate member 94, water level detector 88, as well as wires 152 of the flower pot 70 of FIG. 6 are not shown in FIG. 11, which should be understood as being omitted from the diagram only for convenience of illustration.

The modular flower pot 180 generally includes a normal flower pot 70 as described with reference to FIG. 6. However, the upper section 79 of the flower pot 70 does not directly contain soil but receives the inner container 174 which contains soil (not shown) to bury the roots of plants. The inner container 174 is shaped and sized to fit into the upper section 79 of the flower pot 70. The inner pot 174 includes an open top 177, a cylindrical side wall 178 and a bottom wall 182. Two indents 184 are provided at opposed sides of the side wall 178, extending through the bottom wall 182 to the top edge of the side wall 178 for accommodating the water pipe 84 and breathing pip 154 of the flower pot 70 when the inner container 174 is placed into the upper section 79 of the flower pot 70. The bottom wall 182 of the inner container 174 includes a first group of apertures 184 sized and positioned in accordance with the apertures 114 in the partition 78 of FIG. 7, and a second group of apertures 186 sized and positioned in accordance with the apertures 114′ in the partition 78 of FIG. 7. Thus, the upper sections 118, 128 of the watering spikes 108, 122 can be inserted through the apertures 184 in the bottom wall 182 of the inner container 174 and into the soil (not shown) contained in the inner container 174 when the inner container 174 is placed into the upper section 79 of the flower pot 70. The apertures 186 will be aligned with the perforated plugs 146 which are received in the apertures 114′ in the partition 78 of FIG. 7 and will permit water to flow from the lower section 82 through the perforated plugs 146 into the soil contained in the inner container 174 and will also permit water which is not absorbed by the soil to drain back into the lower section 82 of the flower pot 70.

In FIG. 12 the inner container 174 is provided with the insert 176 which includes a plate 188 and a plurality of sub-spikes 190 extending upwards from the plate 188. The sub-spikes 190 are positioned, sized and shaped to correspond to the upper portion 118, 128 of the watering spikes 108, 122. However, the upper portion 118, 128 of the watering spikes 108, 122 are similar so that the sub-spikes 190 can be of a uniform size. The insert 176 is used to be inserted into the inner container 174 from beneath the bottom wall 182, through the apertures 184 therein, before the roots of a plant are put into the inner container 174 and are buried with soil. The sub-spikes 190 form holes in the soil allowing the plant roots to grow around them. The inner container 174 with the insert 176 inserted therein can be commercially available with the plant already growing therein. The insert 176 can then be removed, making the inner container 174 ready to be placed in the upper section 79 of the flower pot 70 of FIG. 11. The upper sections 118, 128 of watering spikes 108, 122 will fit into the holes made in the soil by the sub-spikes 190 of the insert 176, without the risk of damaging the roots of the plant. The insert 176 also ensures that soil particulates contained in the inner container 174 do not fall through the apertures 184, 186 before the inner container 174 can be placed into the flower pot 70 of FIG. 11.

It is preferable to make the size of the apertures 184 in the bottom wall 182 of the inner container 174 slightly smaller than the size of apertures 114 in the partition 78 of FIG. 7 in order to ensure a snug fit with the sub-spikes 190, when the sub-spikes 190 of the insert 176 are fully inserted into the apertures 184. Thus, the attachment of the insert 176 to the inner container 174 is relatively secure, thereby preventing the insert 176 from accidental detachment from the inner container 174 before it is ready to be placed in the flower pot 70 of FIG. 11. Optionally, simple and well known fastening means such as wires or strips can be provided to ensure the attachment of the insert 176 to the inner container 174.

The plate 188 of the insert 176 may further include small holes 189 in groups corresponding to the second group of apertures 186 in the bottom wall 182 of the inner container 174, in order to prevent soil particulates from falling through with draining water while the plant growing from the inner container 174 is being watered, before it is placed into flower pot 70. However, this is optional because water drains from the small gap between the plate 188 of the insert 176 and the bottom wall 182 of the inner container 174 if the holes with the perforated plugs 146 are not provided.

A plurality of small holes 192 are also optionally provided all around the side wall 178 of the inner container 174 and are located just below the top edge of the side wall 178, to permit water to run over during a watering process. These holes 192 function much the same as the holes 158 in the breathing pipe 154 of FIG. 10 because the gap formed between the side wall 178 of the inner container 174 and the side wall 76 of the flower pot 70 will function similarly to the breathing pipe 154 of FIG. 10 when the inner container 174 is placed in the upper section 79 of the flower pot 70.

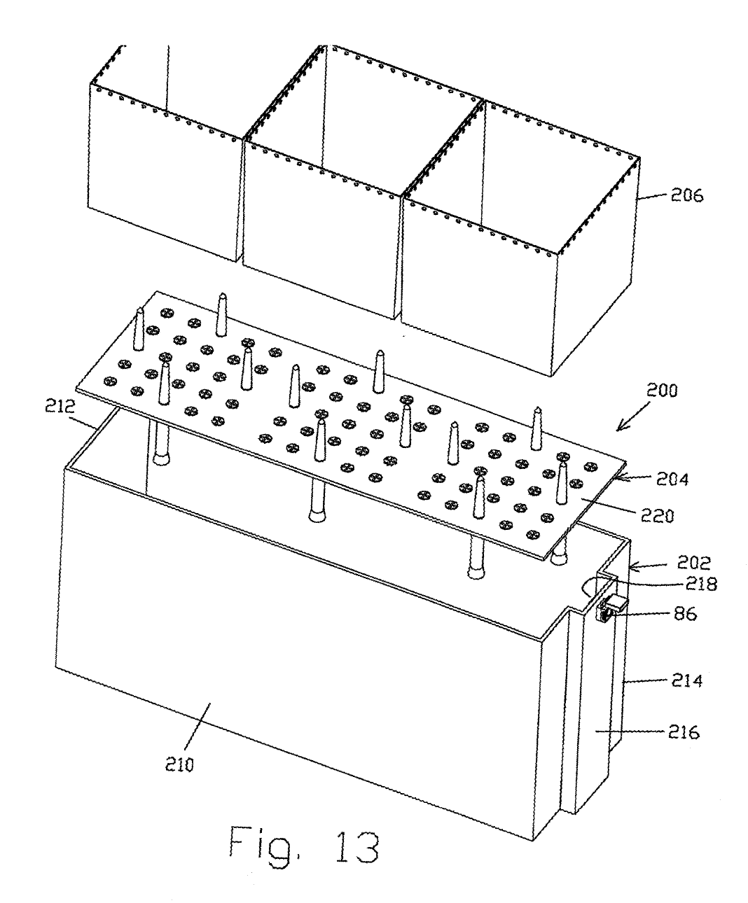

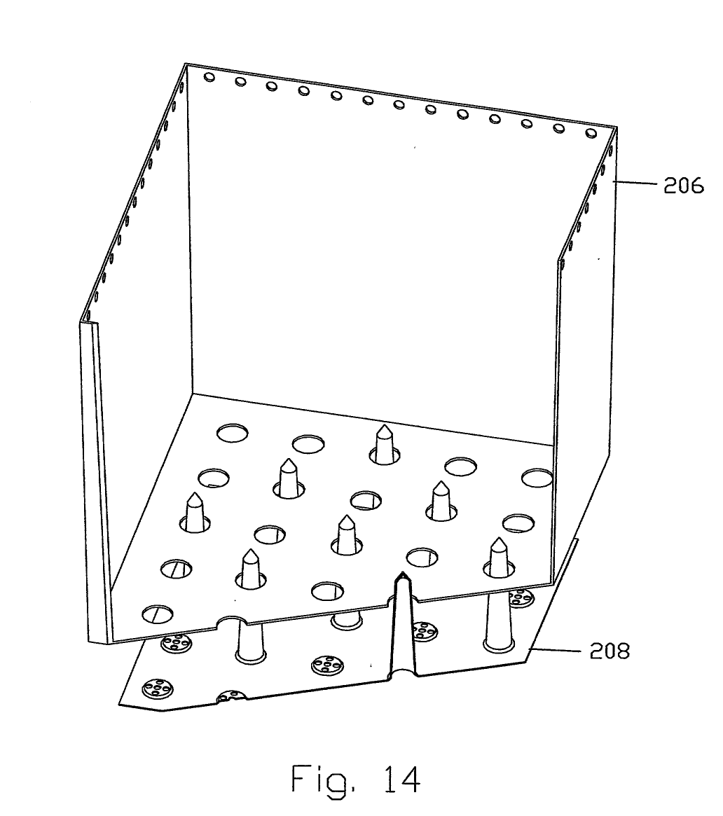

FIGS. 13 and 14 illustrate a rectangular modular plant container 200 which includes a rectangular flower box 202, a partition and watering spike assembly 204 and three square inner containers 206. Each of the three inner containers 206 is provided with a square insert 208. The rectangular flower box 202 includes two straight side walls 210, one straight end wall 212 and other end wall 214 which has an extension 216 extending outwardly from the end wall 214 to form an additional space 218. This additional space 218 accommodates the water pipe, the breathing pipe, water level detecting switches which are not shown and are similar to those of flower pot 70, but are all located at the end wall 214 of the flower box 202. The hydro-electric connector 86 is attached to the extension 216. Thus, the rectangular space within the flower box 202 defined by the side walls 210 and end walls 212 , 214 is kept clear for receiving the partition and watering spike assembly 204 and the three square inner containers 206. Therefore the inner containers 206 can be manufactured using a uniform design, thereby avoiding the necessity of a second design with special indents for accommodating a water pipe or breathing pipe. No holes or recesses are needed in the partition 220 to permit the water pipe and breathing pipe to pass through.

The space 218 will function as the breathing pipe when the inner containers 206 are placed within the flower box 202 and therefore, the breathing pipe may be optionally omitted.

The other components and features of the rectangular modular flower container 200 are similar to the flower pot 70 and the modular flower pot 180 and will be self-explanatory by the illustration in FIGS. 13 and 14. The modular flower container 200 may also be made for use outdoors, by omitting electric and electronic components and providing a relief valve and water level indicator similar to flower pot 170.

The inner containers 174, 206 and their inserts 176 and 208 are made of light and disposable materials so that the inner containers and inserts are used only once while the flower pots and flower boxes are designed for repeated use.

The rectangular flower container 200 illustrated in FIG. 13 advantageously provides the convenience of accommodating a combination of flowers or plants which are grown in the individual inner containers 206. When plants such as trees are combined with blooming plants, for example the blooming plants will die before the trees do. The blooming plant can simply be removed together with its disposable inner container 206 from the flower box 200 and can be replaced by a new blooming plant contained in another disposable inner container 206 which will be inserted into the same position in the flower box 200.

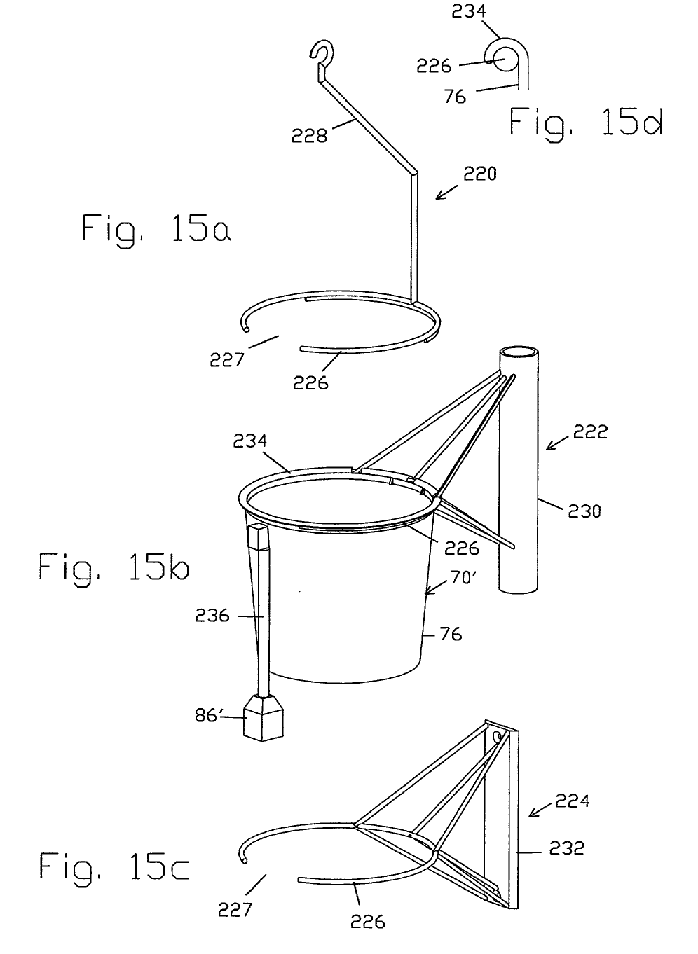

FIGS. 15a-15c illustrate three different types of hangers 220, 222 and 224. Each of the hangers include a support ring 226 which is a partial ring with an opening 227, as illustrated. The hanger 220 further includes a suspending structure 228 for hanging a flower pot (not shown) supported on the support ring 226 from, for example, a hook affixed to a ceiling (not shown). The hanger 222 further includes a cantilevered structure 230 for supporting the flower pot 70′ on a post (not shown). The hanger 224 further includes a cantilevered structure 232 for supporting the flower pot (not shown), on, for example, a wall. The flower pot 70′ as shown in FIG. 15b includes a curved flange 234 at the top edge of the side wall 76 of the flower pot 70′, as shown in FIG. 15d, forming an annular groove beneath the curved flange 234 to receive the support ring 226 therein when the flower pot 70′ is placed into the support ring 226. The hanging flower pots 70′ are generally smaller in size compared to the floor models. The reservoir at the bottom of the flower pot 70′ is relatively small. The use of the two switches and float with magnet can be easily omitted in this design. The hydro-connector 86′ is attached through an extension 236 to the side wall 76 of the flower pot 70′ at a position near or below the curved flange 234 in order to be connected to the water pipe (not visible) inside of the flower pot 70′. The hydro-connector connector 86′ is particularly designed for connection which can be made conveniently from below when the flower pot 70′ is suspended from a hanger. The opening 227 of the support ring 226 provides a passage for the hydro-connector 86′ to pass therethrough when the flower pot 70′ is placed into the support ring 226.

It is to be understood that the invention is not limited to the illustrations described and shown herein, and the invention rather is intended to encompass all modifications that are within its spirit and scope as defined by the appended claims.

I claim:

1. A method of watering a plant having roots in soil contained in a container, comprising:
introducing water under pressure into a bottom of the container through a water passage extending from the bottom of the container upwardly out of the container, until a top portion of soil in the container is flooded with water; and then
removing a portion of water not absorbed by the soil from the container.

2. A method as claimed in claim 1 wherein the removal of the portion of water not absorbed by the soil from the container is conducted through the water passage under a vacuum action.

3. A method as claimed in claim 2 wherein water is introduced into a space between the bottom of the container and a bottom portion of soil, the space being adapted for collecting water drained from the soil and in fluid communication with the passage.

4. A method as claimed in claim 2 further comprising a step of maintaining water in the container for a short period of time prior to the removal step to ensure that the soil in the container is saturated with water.

5. A method as claimed in claim 3 wherein the removal of the portion of water not absorbed by the soil is controlled to leave a selected volume of water in the space for moistening the soil using means for delivering moisture via capillary action, the volume of water left in the space being limited to ensure that the water should not reach the bottom of the soil.

6. A plant container for growing plants comprising:
a container having an open top, a closed bottom and a side wall extending from the bottom to the top;
a partition across the container dividing the container into an upper section for containing soil and a lower section for collecting water, the partition being adapted to permit water to alternately flow therethrough in both directions;
a water passage in fluid communication with the lower section, extending from the proximity of the bottom of the container to the top of the container for alternately introducing water under pressure into the lower section and removing water under a vacuum action from the lower section;
a water detector positioned near the top of the container, adapted for detecting a water flood condition of a top surface of soil contained in the upper section of the container; and
a hydro-electric connector attached to the container, electrically connected to the water detector and connected in fluid communication with the water passage, the hydro-electric connector being adapted for connection with an external water supply and withdrawal system to alternately introduce water into and remove water from the lower section, in a controlled manner.

7. A plant container as claimed in claim 6 further comprising:
a first pipe made of water impermeable material, forming the water passage, the first pipe extending along the side wall, crossing the partition, and including a lower end positioned in the proximity of the bottom of the container and a upper end connected to the hydro-electric connector attached to the container at the top thereof; and
a second pipe extending from the lower section to the top of the container, the second pipe being in fluid communication with the lower section and atmosphere.

8. A plant container as claimed in claim 7 wherein the partition comprises a plurality of apertures to permit water to flow therethrough and means for delivering moisture via capillary action from the lower section to the upper section when soil is filled in the upper section and water is collected in the lower section of the container.

9. A plant container as claimed in claim 8 comprising means for sensing water levels in the lower section of the container, adapted to sense a first water level close to the bottom of the container and a second level close to the partition, the means being electrically connected to the hydro-electric connector.

10. A plant container as claimed in claim 9 wherein the means for sensing water levels comprises:
a first switch positioned at the bottom of the container;
a second switch positioned immediately beneath the partition; and
a float member adapted to be floating in the water collected in the lower section to activate the respective switches when the float member reaches a level where the respective switches are positioned.

11. A plant container as claimed in claim 8 comprising a stick attached at a lower end thereof to a float member, the stick extending through the second pipe and being adapted to indicate levels of the water collected in the lower section of the container.

12. A plant container as claimed in claim 8 wherein the means for delivering moisture comprises a plurality of spike members made of rigid water-absorbent material, extending upwards from the bottom of the container through the partition and into the upper section, the combination of the spike members supporting the partition within the container.

13. A plant container as claimed in claim 12 wherein at least one of the spike members is releasably secured to the bottom of the container to prevent the partition from being removed from the container.

14. A plant container for growing plants comprising:
a container having an open top, a closed bottom and a side wall extending from the bottom to the top;
a partition across the container dividing the container into an upper section for containing soil and a lower section for collecting water, the partition being adapted to permit water to alternately flow therethrough in both directions; and
a valve connected to an opening in the sidewall of the container located immediately below the partition for selectively draining excess water when the lower section of the container is full of water.

15. A plant container as claimed in claim 14 further comprising:
a first pipe in fluid communication with the lower section for alternately introducing water under pressure into the lower section and removing water under a vacuum action from the lower section, the first pipe being made of water impermeable material, extending along the side wall, crossing the partition, and including a lower end positioned in the proximity of the bottom of the container and a upper end positioned at the top of the container; and
a connector attached to the container and connected to the upper end of the first pipe, and being adapted for connection with an external water supply and withdrawal system to alternately introduce water into and remove water from the lower section, in a controlled manner.

16. A plant container as claimed in claim 15 wherein the partition comprises a plurality of apertures to permit water to flow therethrough and means for delivering moisture via capillary action from the lower section to the upper section when soil is filled in the upper section and water is collected in the lower section of the container.

17. A plant container as claimed in claim 16 further comprising:
a second pipe extending from the lower section to the top of the container, the second pipe being in fluid communication with the lower section and atmosphere; and
a stick attached at a lower end thereof to a float member, the stick extending through the second pipe and being adapted to indicate levels of the water collected in the lower section of the container.

18. A modular plant container for growing plants comprising:
a first container having an open top, a closed bottom and a side wall extending from the bottom to the top;
a partition across the first container dividing the container into an upper section and a lower section for collecting water, the partition having apertures to permit water to alternately flow therethrough in both directions;
a water passage in fluid communication with the lower section, extending from the proximity of the bottom to the top of the first container for alternately introducing water under pressure into the lower section and removing water under a vacuum action from the lower section;
a plurality of spike members made of rigid water-absorbent material for delivering moisture under capillary action, extending upwards from the bottom of the first container through the partition into the upper section, the combination of the spike members supporting the partition within the first container;
a second container for containing soil therein shaped and sized to fit in the upper section of the first container, the second container including a first group of apertures in a bottom thereof corresponding to the apertures in the partition to permit water to flow, and a second group of apertures to receive the spike members passing therethrough when the second container is placed into the upper section of the first container; and
an insert including a plate and a plurality of sub-spikes extending upwards from the plate for forming holes in soil contained in the second container when the sub-spikes are inserted into the second container through the spike member receiving apertures in the bottom thereof, the sub-spikes being sized and shaped to correspond to an upper portion of the spike members above the partition so that the second container with soil and a plant having roots therein is ready to be placed into the upper section of the first container after the insert is removed therefrom.

19. A plant container as claimed in claim 18 wherein the second container and the insert are made of a light and disposable material.

20. A plant container as claimed in claim 18 wherein the second container comprises a plurality of holes in the sidewall near a top edge thereof.

21. A partition and spike assembly for use with a plant container for creating a water reservoir in the container and generating capillary action to moisten soil in the container after plant watering, comprising:
a partition adapted to be placed in the container, dividing the container into an upper section for containing soil and a lower section for collecting water, the partition being adapted to permit water to alternately flow therethrough in both directions; and
a plurality of spike members made of rigid water-absorbent material, the spike members extending through and supporting the partition when the assembly is placed in the container so that the spike members deliver moisture under capillary action from lower sections thereof which are submerged in water collected in the lower section of the container to upper sections thereof which are buried in the soil contained in the upper section of the container.

22. A partition and spike assembly as claimed in claim 21 wherein the assembly is made in a one-piece configuration with a plurality of holes through the partition.

23. A partition and spike assembly as claimed in claim 22 wherein the assembly is made of baked clay.
